(19) United States
(12) Patent Application Publication
(10) Pub. No.: US 2008/0007151 A1
(43) Pub. Date: Jan. 10, 2008

(54) IMAGE DISPLAY DEVICE AND SPACER FOR USE THEREIN

(76) Inventors: Takashi Naitou, Funabashi (JP); Yuichi Sawai, Mito (JP); Osamu Shiono, Hitachi (JP); Mitsuo Hayashibara, Hitachinaka (JP); Hiroshi Ito, Chiba (JP); Akira Hatori, Chiba (JP); Nobuhiko Hosotani, Mobara (JP); Shoji Shirai, Mobara (JP); Shigemi Hirasawa, Chiba (JP); Keiichi Kanazawa, Ome (JP); Hiroyuki Akata, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/773,591

(22) Filed: Jul. 5, 2007

(30) Foreign Application Priority Data
Jul. 4, 2006 (JP) 2006-184541

(51) Int. Cl. H01J 19/42; H01J 63/04; H01J 1/62

(52) U.S. Cl. 313/495; 313/238; 313/257

(57) ABSTRACT

A spacer of the present invention for use in an image display device, which has the spacer between a cathode substrate with a cold cathode electron emitting device formed thereon and an anode substrate with a phosphor formed thereon, comprises a phosphate glass having transition metal oxides as its main components, and a higher phosphate concentration layer at the spacer surface. A thickness of the higher phosphate concentration layer is suppressed to 0.5 μm or less. More preferably, the spacer has a water resistant conductive passivation layer formed on its surface. This suppresses the thickness of the higher phosphate concentration layer to a thinner level, so that the spacer is less likely to be charged thus reducing the deflection amount of electron beam. An image display device of the present invention using above spacer can apply a higher voltage to the anode substrate, thus increasing the image quality.

The present application claims priority from Japanese application serial no. 2006-184541 filed on Jul. 4, 2006, the content of which is hereby incorporated by reference into this application.

### BACKGROUND OF THE INVENTION

1. Field of the Invention

The present invention relates to image display devices which form an image by emitting electrons into a vacuum and by colliding them with a phosphor for luminescence. More particularly, the present invention relates to flat panel displays and spacers for use therein which have a configuration in which a cathode substrate having a cold cathode electron emitting device is disposed against an anode substrate having a phosphor with a spacer interposed between them.

2. Description of the Related Art

As the image quality of information processing systems or TV broadcasting systems has increased in recent years, flat panel displays (FPDs) have caught attention because they have high brightness and precision as well as light weight and small space. Typical flat panel displays include liquid crystal displays, plasma displays and field emission displays (henceforth referred to as FEDs) which draw recent attention.

FEDs are spontaneous luminous displays which have an electron source configured with electron emitting elements of a cold cathode electron emitting device disposed in a matrix arrangement. It is known that electron emitting devices include a surface-conduction electron-emitter display (SED) type, field emission (FE) type, metal-insulator-metal (MIM) type or the like. Further, it is well-known that FE types include a Spindt type made up of a metal such as molybdenum or a semiconductor material such as silicon, a CNT type using a carbon nanotube as its electron source, or the like.

An FED includes a rear panel having an electron source formed thereon and a front panel having a phosphor formed thereon which is excited by electrons released from the electron source and emits light to a space interposed between them. It is necessary that this space is maintained at a vacuum. Therefore, a sealing frame is provided along the inner periphery of the rear and front panels. In addition, in order for the space maintained at a vacuum to withstand the atmospheric pressure, a supporting member called a spacer is disposed between both panels.

A spacer for FPD is proposed in which the spacer is configured by forming a semi-conducting layer on the surface of an insulating base and further forming a loop-like conductor encircling the surface (e.g., refer to JP P1998-241606A). Another spacer for FPD is proposed in which the spacer is configured by forming a conductive film on the surface of an insulating glass base (e.g., refer to JP P2004-171968A).

In a flat panel display using an electron source, a voltage applied to the anode provides a potential difference between the electron source and anode typically on the order of 3 to 10 kV. Increasing the voltage applied can provide a panel of a higher brightness and a longer lifetime but cause the spacer disposed between the rear and front panels to be more easily charged. A charged spacer leads to a phenomenon in which an electron beam traveling from the cathode to the anode is attracted toward or repelled from the spacer. This poses a problem because this may change the brightness of the screen or display a shadow image of the spacer on the screen, thus deteriorating the image quality. Furthermore, a discharge is likely to occur, possibly damaging the cathode or other structural components.

In order to prevent the charging of the spacer, it is necessary to provide the spacer with some extent of conductivity. To solve this problem, above-mentioned spacer having a conducting layer on the surface of a base made of an insulating material is disclosed, as described in the above-mentioned Japanese Patent Laid-open Nos. e.g., JP P1998-241606A and JP P2004-171968A. However, the antistatic characteristics of these spacers are inadequate under the condition of high potential difference.

### SUMMARY OF THE INVENTION

It is an object of the present invention is to provide an image display device and a spacer for use therein in which charging under electron irradiation is more easily removed, thereby reducing the deflection amount of electron beam.

(1) According to an embodiment of the present invention, an image display device comprises a cathode substrate with a cold cathode electron emitting device formed thereon, an anode substrate with a phosphor formed thereon, and a spacer disposed between and supporting the cathode and anode substrates; wherein the spacer is made of a phosphate glass having transition metal oxides as its main components, and the thickness of a higher phosphate concentration layer at the spacer surface is 0.5 μm or less.

(2) According to another embodiment of the present invention, an image display device comprises a cathode substrate with a cold cathode electron emitting device formed thereon, an anode substrate with a phosphor formed thereon, and a spacer disposed between and supporting the cathode and anode substrates; wherein the spacer is made of a phosphate glass having transition metal oxides as its main components; the thickness of a higher phosphate concentration layer at the spacer surface is 0.5 μm or less; and the spacer has on its surface a conductive passivation layer containing highly polar elements.

(3) According to another embodiment of the present invention, a spacer for use in an image display device, which has the spacer between a cathode substrate with a cold cathode electron emitting device formed thereon and an anode substrate with a phosphor formed thereon; comprises a phosphate glass having transition metal oxides as its main components, and a higher phosphate concentration layer at the spacer surface; wherein a thickness of the higher phosphate concentration layer is 0.5 μm or less.

In the above inventions (1), (2) and (3), the following modifications and changes can be made.

(i) A transition metal oxide contained in the phosphate glass is at least one selected from a group consisting of vanadium oxides, tungsten oxides and molybdenum oxides.

(ii) The phosphate glass includes one of: a W—V—P—Ba—O glass which contains tungsten oxides and vanadium oxides, and further contains phosphorus oxides and barium oxide as a vitrification component; and a W-V-Mo-P-Ba-O glass which further contains molybdenum oxides in addition to the W—V—P—Ba—O glass.

(iii) The phosphate glass contains substantially no alkali metal.

(iv) The amount of alkali metal in the phosphate glass is suppressed to 0.5 mass % or less in terms of oxide.

(v) A specific resistance of the spacer is an order of 10⁷ to 10¹⁰ Ωcm.

(vi) An anode voltage applied to the anode substrate is within a range of 10 to 15 kV.

(vii) The conductive passivation layer includes one of tin-based and zinc-based oxides.

(Advantages of the Invention)

According to the present invention, it is possible to provide a spacer for use in an image display device, in which the thickness of the higher phosphate concentration layer is suppressed to a thinner level so that the spacer is less likely to be charged. Further, it is possible to provide an image display device including the above-mentioned spacer has an effect of reducing the deflection amount of electron beam and thus improving image quality.

### BRIEF DESCRIPTION OF THE DRAWINGS

FIG. 1 is a schematic illustration showing a side view of a spacer according to a preferred embodiment of the present invention is disposed between cathode and anode substrates of a flat panel display.

FIG. 2A is a schematic illustration showing a perspective view of an overall configuration of the flat panel display according to a preferred embodiment of the present invention.

FIG. 2B is a schematic illustration showing a cross sectional view cutting along A-A line in FIG. 2A.

FIG. 3 is a schematic illustration showing a cross sectional view from front to back of the flat panel display according to a preferred embodiment of the present invention.

FIG. 4 is a schematic illustration showing a cross sectional view detailing a portion of FIG. 3.

FIG. 5 is a schematic illustration specifically showing a perspective view of an overall configuration of the flat panel display, in which a portion thereof is cut away, according to a preferred embodiment of the present invention.

FIG. 6 is a schematic illustration showing a cross sectional view cutting along B-B line in FIG. 5.

FIG. 7 is a schematic illustration showing a configuration example of a pixel in the flat panel display according to a preferred embodiment of the present invention.

FIG. 8 is a schematic illustration of an example of an equivalent circuit of the flat panel display according to a preferred embodiment of the present invention.

FIG. 9 is a graph representing a relationship between the deflection amount of electron beam and thickness of a higher phosphate concentration layer at the spacer surface in an image display device according to a preferred embodiment of the present invention.

### DETAILED DESCRIPTION OF THE PREFERRED EMBODYMENTS

Preferred embodiments of the present invention will be described below with reference to the drawings. However, the present invention is not limited to the embodiments described herein.

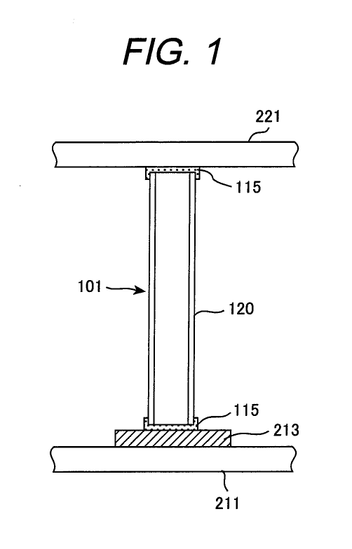

FIG. 1 is a schematic illustration showing a side view of a spacer according to a preferred embodiment of the present invention is disposed between cathode and anode substrates of a flat panel display. In FIG. 1, a spacer 101 includes a conductive phosphate glass having transition metal oxides as its main components. A higher phosphate concentration layer 120 is formed at the surface of the spacer 101, the thickness of which is suppressed to 0.5 μm or less. The spacer 101 is disposed between a cathode substrate 211 in a rear panel and an anode substrate 221 in a front panel, and is bonded to each substrate with a conductive adhesive 115.

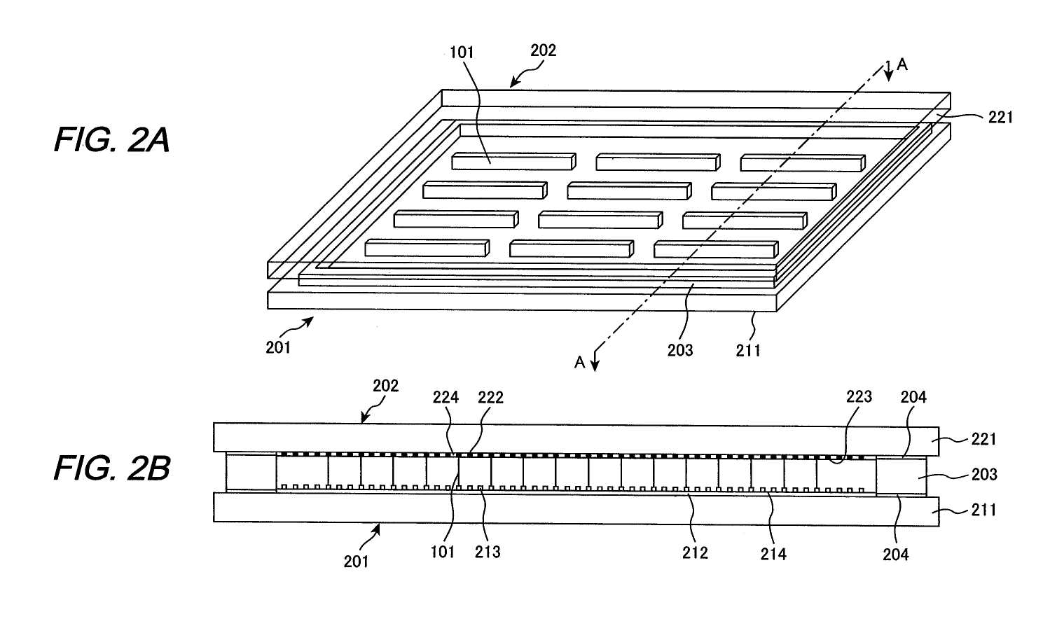

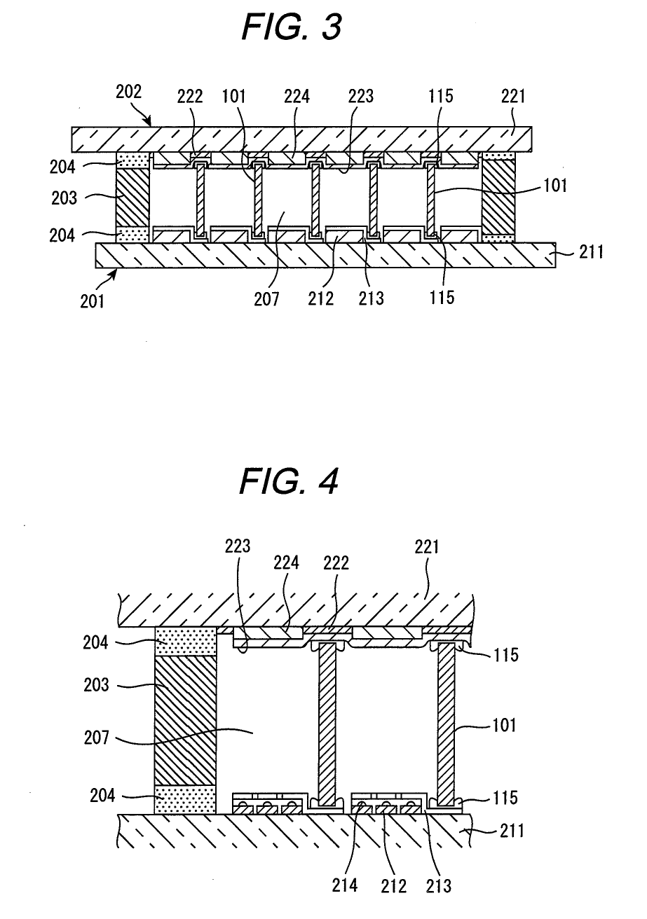

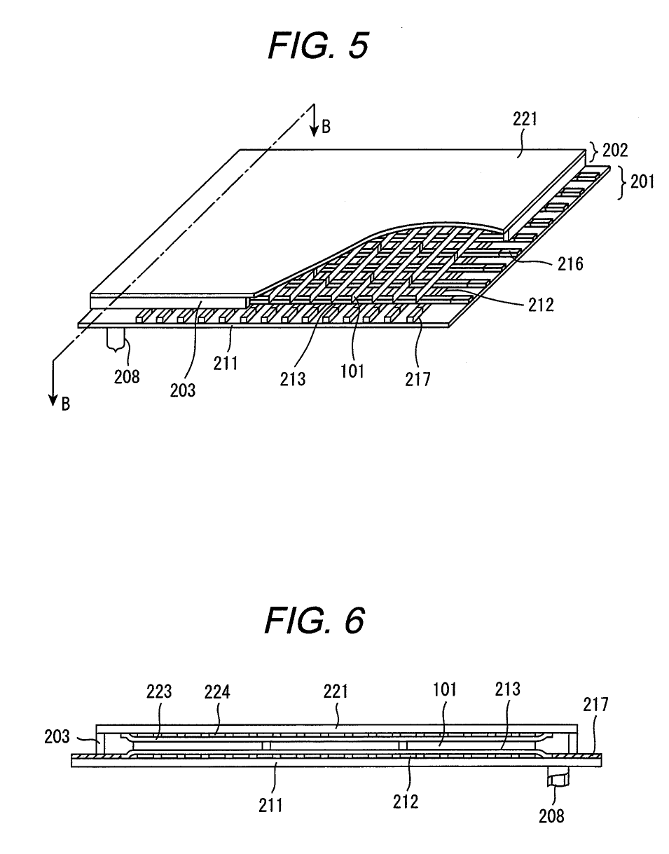

FIG. 2A is a schematic illustration showing a perspective view of an overall configuration of the flat panel display according to a preferred embodiment of the present invention. FIG. 2B is a schematic illustration showing a cross sectional view cutting along A-A line in FIG. 2A. FIG. 3 is a schematic illustration showing a cross sectional view from front to back of the flat panel display according to a preferred embodiment of the present invention. FIG. 4 is a schematic illustration showing a cross sectional view detailing a portion of FIG. 3. FIG. 5 is a schematic illustration specifically showing a perspective view of an overall configuration of the flat panel display, in which a portion thereof is cut away, according to a preferred embodiment of the present invention. FIG. 6 is a schematic illustration showing a cross sectional view cutting along B-B line in FIG. 5. As shown in FIGS. 2A to 6, a rear panel 201 has a signal line (data line, cathode electrode line) 212 and a scanning line (gate electrode line) 213 on the inner surface side of the cathode substrate 211 which is a panel base, and an electron source 214 is formed in a vicinity of the intersection of those two lines. The electron source 214 is configured such that cold cathode electron emitting elements are arranged in a matrix. At an edge of the scanning line 213 is formed a scanning line extractor 216 as shown in FIG. 5, while a signal line extractor 217 is formed at an edge of the signal line 212 as shown in FIGS. 5 and 6.

A front panel 202 has a light shielding film (black matrix) 222, an anode (metal back) 223 and a phosphor layer 224 on the inner surface side of the anode substrate 221 which is a panel base. Although the structure of the spacer 101 is represented as a single plate for simplifying in FIGS. 2A to 6, it is configured actually as shown in FIG. 1.

Along the inner periphery of the cathode substrate 211 and anode substrate 221 is provided a sealing frame (frame glass) 203, which is bonded to the cathode and anode substrates with an adhesive to form a sealing adhesive layer 204. Thereby, a space portion between the rear and front panels is formed. The space portion is maintained at a vacuum of typically 10⁻⁵ to 10⁻⁷ Torr, and provides a display region 207. In order to maintain the display region 207 at a vacuum, an exhaust pipe 208 is connected to a portion of the rear panel 201 as shown in FIGS. 5 and 6.

The spacer 101 is disposed between the scanning line 213 formed on the inner surface of the cathode substrate 211 and the light shielding film (black matrix) 222 formed on the inner surface of the anode substrate 221, and is bonded to them with the conductive adhesive 115. Although three spacers are disposed along the scanning line 213 as shown in FIGS. 2A to 6, it is just an example, and e.g., a single long spacer may be disposed.

The cathode substrate 211 is preferably made of glasses or ceramics such as alumina. While, transparent glasses are preferred as materials for the anode substrate 221. A glass plate is often used for the cathode substrate. The distance between the cathode and anode substrates is maintained at typically about 2 to 5 mm.

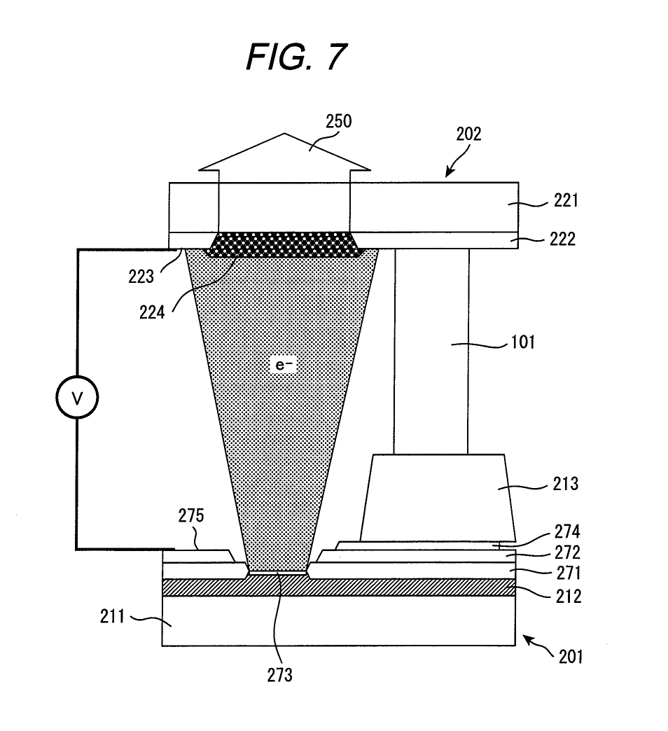

FIG. 7 is a schematic illustration showing a configuration example of a pixel in the flat panel display according to a preferred embodiment of the present invention. On the main surface (inner surface) of the cathode substrate 211 in the rear panel 201 are formed: the signal line 212 preferably of an aluminum layer which is the lower electrode of the electron source; a first insulating film 271 of an anodized oxide film formed by anodizing the aluminum of the lower electrode; a second insulating film 272 preferably of a silicon nitride (SiN) film; a power supply electrode (connecting electrode) 274; the scanning line 213 preferably of chromium; and a upper electrode 275 which is the electron source of the pixel connected to the scanning line 213.

The electron source utilizes the signal line 212 as the lower electrode, and includes a thin film portion 273 which is located on the lower electrode and forms a portion of the first insulating film 271, and a upper electrode portion 275 stacked over the thin film portion 273. The upper electrode portion 275 is formed to cover a portion of the scanning line 213 and power supply electrode 274. The thin film portion 273 is a so-called tunneling film. This configuration forms a so-called diode electron source.

On the main surface of the anode substrate 221, preferably a transparent glass substrate, in the front panel 202 are formed: the phosphor layer 224 separated from an adjacent pixel by the light shielding film (black matrix) 222; and the anode 223 preferably of a vapor deposited aluminum film. The spacer 101 is disposed between the rear panel 201 and front panel 202.

In the thus configured flat panel display, an accelerating voltage (a potential difference) between the upper electrode 275 of the rear panel 201 and the anode 223 of the front panel 202 causes a release of electrons e⁻ by an amount corresponding to a magnitude of a display data supplied from the signal line 212 as the lower electrode. The released electrons are then driven by the accelerating voltage to impinge on and excite the phosphor layer 224, which emits light 250 of a specific frequency outward through the front panel 202. In a full-color display, this unit pixel corresponds to a color sub-pixel, and one color pixel typically includes three sub-pixels of red (R), green (G) and blue (B).

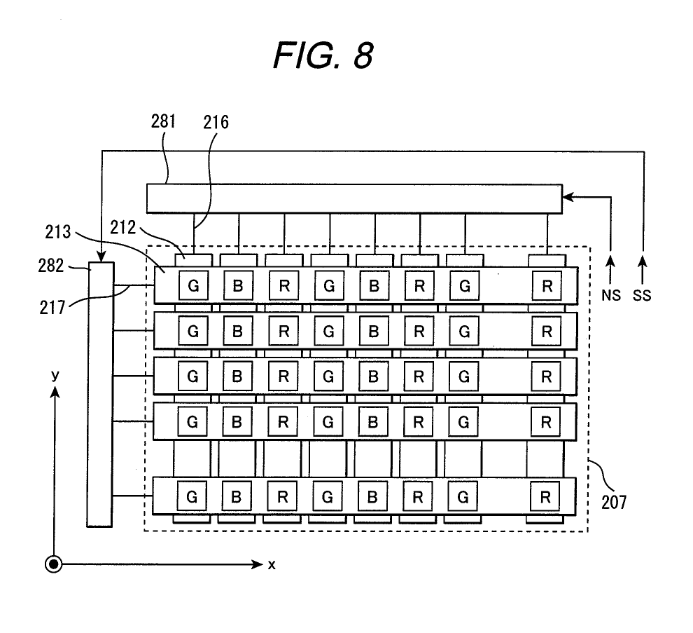

FIG. 8 is a schematic illustration of an example of an equivalent circuit of the flat panel display according to a preferred embodiment of the present invention. In FIG. 8, the region surrounded by the broken line corresponds to a display region 207, where n signal lines 212 and m scanning lines 213 are intersected with each other to form an n×m matrix. One sub-pixel is formed at each intersection of the matrix, and one color pixel includes three unit pixels (sub-pixels), i.e., one group of R, G and B in FIG. 8. The signal line 212 is connected to an image signal driver circuit 281 through the signal line extractor 216, while the scanning line 213 is connected to a scanning signal driver circuit 282 through the scanning line extractor 217. An image signal NS is inputted to the image signal driver circuit 281 from an external signal source, while a scanning signal SS is similarly inputted to the scanning signal driver circuit 282.

Thus, a two-dimensional full-color image can be displayed by supplying corresponding image signals to the signal lines 212 which intersect with the sequentially selected scanning lines 213.

As described before, in a flat panel display, a spacer is prone to be charged with electrons traveling from an electron emitting device. Near the charged spacer, the trajectories of the electron beams released from the electron emitting device are easy to be deflected such that the electron beams are either attracted toward or repelled from the charged spacer, thus degrading the image quality. In order to suppress the electrification of the spacer and the deflection of electron beams, it is desirable to form a conductive layer on the spacer surface, or to provide the spacer itself with some extent of conductivity, thereby allowing a small electric current to flow through the spacer surface.

Because phosphate glasses containing transition metal oxides have an electric conductivity, they are preferable for the spacer of an image display device. However, the inventors have found that some of the spacers containing transition metal oxides to increase the electric conductivity were still prone to be charged. In order to clarify the reason, the inventors investigated the spacers that were prone to be charged. Thereupon, it was found that the phosphate concentration at the surface of the spacer was higher than that of the inside. It was considered that moisture deposition on the spacer surface, e.g., during storage thereof, attracted the phosphate of its inside toward its surface. The glass spacer is typically fabricated by, e.g., a method in which raw powders are blended, molten in a melting furnace and then drawn. Composition of the glass spacer is uniformly distributed. However, during storage of the spacer, a layer of a higher phosphate concentration is formed at the spacer surface by an influence of humidity in the atmosphere. This results in a decrease in the transition metal concentration at the surface portion of the spacer, and this increases the electric resistivity at the spacer surface, causing the spacer more likely to be charged.

Further investigation showed that suppressing the thickness of the higher phosphate concentration layer at the spacer surface to 0.5 μm or less was effective to reduce the charging. At a thickness of the higher phosphate concentration layer more than 0.5 μm, the spacer surface becomes prone to be charged thereby increasing the amount of beam deflection, and this causes a shadow of the spacer to appear on a screen. Preferable methods for suppressing the thickness of the higher phosphate concentration layer at the spacer surface to 0.5 μm or less are shown in (1) to (4) below. Of course, the invention is not limited to these suppression methods.

(1) The spacer is vacuum packed for storage.

(2) The spacer is dipped into water after fabrication in order to elute the phosphate on the surface.

(3) A conductive passivation layer with a water resistant is formed on the spacer surface during or after fabrication. Specifically, the conductive passivation layer is preferably formed containing highly polar elements. Highly polar elements have an effect of repelling moisture. For example, the conductive passivation layer is preferably formed including tin oxide or zinc oxide. A thickness of 0.1 μm or less is sufficient for the thickness of the water resistant conductive passivation layer of a tin-based oxide, depending on the material coated. The thickness is preferably 0.02 μm or more.

(4) No alkali metal is preferably contained in the phosphate glass. If such alkali metal is contained, the amount is preferably limited to 0.5 mass % or less in terms of oxide. The alkali metal contained as a component of the glass increases the hygroscopicity of the glass, thereby causing a higher phosphate concentration layer more likely to form at the spacer surface.

In the case where the spacer is vacuum packed for storage, it is preferable to assemble the spacer in an image display device immediately after removing it from a vacuum package.

In the spacer of the present invention, the thickness of the higher phosphate concentration layer is suppressed to a thinner level. It leads transition metal concentration in the surface region of the spacer not to decrease, thereby decreasing the electric resistivity at the surface. As a result, the spacer becomes less likely to be charged, thus reducing the deflection amount of electron beam.

The spacer having a water resistant conductive passivation layer on its surface can be fabricated, e.g., by melting a glass preform with a desired glass composition, drawing it and spraying a tin-based or zinc-based coating liquid to its surface during the drawing, and followed by heating and baking.

This method will now be described in more details. At first, glass raw materials are blended, mixed and molten to prepare a glass ingot. The ingot is then processed to prepare a glass preform. The preform is loaded into a draw furnace. Below the draw furnace are placed: a spraying apparatus for spraying a coating liquid for forming a conductive passivation film; and a baking furnace for heating and baking the coating material. The glass preform for a spacer is drawn from the draw furnace while being sprayed with a tin-based or zinc-based coating liquid by the spraying apparatus, and then baked in the baking furnace. In this way, a spacer having a tin-based or zinc-based oxide as a conductive layer on its glass surface can be fabricated. Tin-based or zinc-based oxides have an effect of preventing the attack of moisture in the atmosphere, thus suppressing the formation of a higher phosphate concentration layer at the surface of the glass spacer.

The spacer of the present invention preferably contains the transition metal oxides as its main components, more preferably at least one selected from a group consisting of vanadium oxides, tungsten oxides and molybdenum oxides. Of these, vanadium oxides are particularly preferable. These oxides all exhibit an electric conductivity in a glass, thus providing an effect of suppressing charging. Among these oxides, vanadium oxides have the highest electric conductivity, then tungsten oxides, then molybdenum oxides. In addition, tungsten oxides have an effect of increasing the thermal resistance of glass, while molybdenum oxides have an effect of reducing the secondary electron emission of glass. Therefore, the spacer according to the present invention preferably contains vanadium oxides and tungsten oxides, more preferably all these oxides.

Phosphorus oxides necessary for vitrification are mixed in the spacer material in addition to the above-mentioned transition metal oxides. Barium oxide may be mixed in addition to phosphorus oxides. Furthermore, the thermal expansion coefficient of glass can be controlled by varying the content of barium oxides.

The present invention proposes that the spacer material includes either: a W—V—P—Ba—Oglass which contains vanadium oxides, tungsten oxides, barium oxide and phosphorus oxides; or a W-V-Mo-P-Ba-O glass which further contains molybdenum oxides; and includes substantially no alkali metal.

The specific resistance of the spacer is preferably 10⁷ to 10¹⁰ Ωcm in view of reducing power consumption and preventing charging, and can be controlled by adjusting the content of vanadium oxides, tungsten oxides, or molybdenum oxides. When a specific resistance of the spacer is less than 10⁷ Ωcm, excessive current flows through the spacer, thereby likely to cause a thermal runaway and damage the spacer. On the other hand, when a specific resistance of the spacer is more than 10¹⁰ Ωcm, the spacer is likely to be charged thereby significantly attracting electron beams.

In the image display device according to the preferred embodiments of the present invention, the spacer is less likely to be charged, and this permits the anode voltage to be increased as high as 10 to 15 kV, thus increasing the image quality. An anode voltage in this range can provide a sufficient brightness, and suppress spark generation thereby preventing from damage of the spacer and wiring.

Now will be described experimental results on glass specimens with five different compositions as shown in Table 1.

The spacers were fabricated by a drawing method in which molten glass was continuously drawn from a hole provided at the bottom of a container. On one hand, five spacers without a conductive passivation film were prepared each from glasses A to E in Table 1, respectively. On the other hand, four spacers each having a different conductive passivation film were prepared from a glass with composition A in Table 1. The spacer was 3 mm in height, 0.12 mm in thickness and 350 mm in length.

The spacers without a conductive passivation film which were each prepared from glasses A to E in Table 1 respectively, were measured for the specific resistance (Ωcm, 1 kV) in a vacuum of 10⁻⁶ Pa. The measurement results are shown in Table 1 together with the respective glass compositions.

TABLE 1

| | | | | | | | | Specific |
|---|---|---|---|---|---|---|---|---|
| | | | | | | | | Resistance |
| | | | | | | | | (Ω cm, 1 kV) |
| Base | Composition in Terms of Oxide (mass %) | | | | | | | Measured in a |
| Glass | WO₃ | V₂O₅ | MoO₃ | P₂O₅ | BaO | Gd₂O₃ | Na₂O | Vacuum: 10⁻⁶ Pa |
| A | 30 | 15 | 10 | 30 | 15 | — | — | 1.4 × 10⁹ |
| B | 30 | 15 | 9 | 30 | 15 | 1 | — | 1.7 × 10⁹ |
| C | 30 | 15 | 10 | 30 | 14.5 | — | 0.5 | 1.7 × 10⁹ |
| D | 30 | 15 | 10 | 30 | 14 | — | 1 | 2.3 × 10⁹ |
| E | 30 | 15 | 10 | 30 | 12 | — | 3 | 3.9 × 10⁹ |

The spacers A to E without a conductive passivation layer were measured for the thickness of the higher phosphate concentration layer immediately and one day after drawing by a SIMS analyzer. The measurement results are shown in Table 2. Table 3 shows the thickness of the higher phosphate concentration layer one day after fabrication for four spacers with a conductive passivation layer.

TABLE 2
Thickness of Higher Phosphate Concentration
Layer (SIMS Analysis Result)

| | Immediately after | One Day after |
|---|---|---|
| Spacer | Drawing (μm) | Drawing (μm) |
| A | 0.1 | 0.7 |
| B | 0.1 | 0.4 |
| C | 0.5 | 1.0 |
| D | 0.9 | 1.3 |
| E | 1.4 | 2.1 |

TABLE 3
Thickness of Higher Phosphate Concentration
Layer (SIMS Analysis Result)

| | Base | Coating Film: | One Day after |
|---|---|---|---|
| Spacer | Glass | Thickness | Drawing (μm) |
| a1 | A | Sn-Based: 0.02 μm | <0.1 |
| a2 | A | Sn-Based: 0.05 μm | <0.1 |
| a3 | A | Sn-Based: 0.1 μm | <0.1 |
| a4 | A | Zn-Based: 0.7 μm | <0.1 |

As shown in Table 1, Gadolinium oxide was contained as a component for improving the water resistance in the glass. Spacers whose glass component contained sodium as an alkali metal were also prepared.

As it is clear from the results in Table 2, all spacers exhibited an increase in the thickness of the higher phosphate concentration layer even one day left after fabrication. Although the spacer containing gadolinium oxide had a relatively small thickness of the higher phosphate concentration layer after one day left, as compared with the other spacers, it still showed a substantial increase of the thickness. The spacers containing sodium oxide had a larger thickness of the higher phosphate concentration layer, and the more sodium was contained, the thicker the high phosphate concentration layer was.

In contrast, the spacers having a conductive passivation layer on its surface exhibited no thickness increase in the higher phosphate concentration layer even one day had elapsed after drawing. The three spacers coated with a tin-based oxide each having a different thickness showed no significant difference in the thickness of the higher phosphate concentration layer one day after drawing. In the effect of the conductive passivation layer, there was no difference between tin-based and zinc-based oxides. A thinner conductive passivation layer is preferable if possible. As seen from the experimental results in Table 3, the thicknesses of tin-based and zinc-based oxides are preferably 0.1 μm or less and 1 μm or less, respectively.

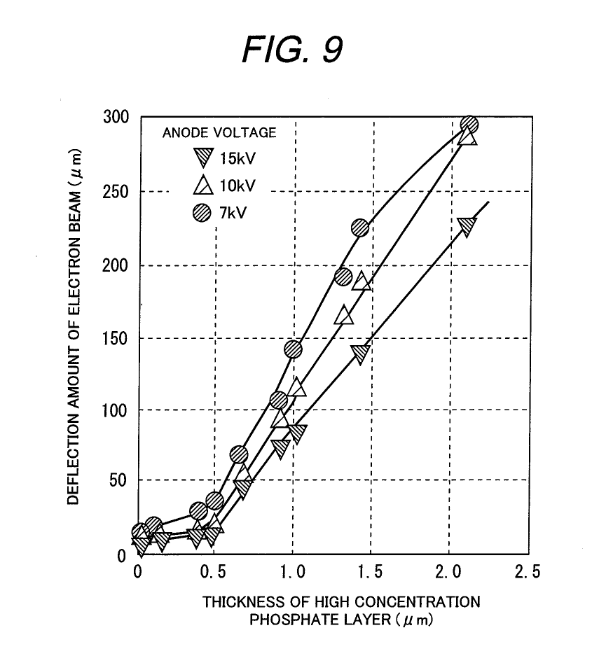

Flat panel displays having a 3 mm space between cathode and anode substrates were fabricated using above spacers shown in Tables 2 and 3. The deflection amounts of electron beam were measured at a vacuum of 10⁻⁶ Pa inside the panel and at three different anode voltages of 7, 10, and 15 kV. The results are shown in FIG. 9. FIG. 9 is a graph representing a relationship between the deflection amount of electron beam and the thickness of the higher phosphate concentration layer at the spacer surface. In flat panel displays according to the preferred embodiment of the present invention, even if an anode voltage higher than 10 kV was applied, the deflection amount of electron beam was still small because the thickness of a higher phosphate concentration layer at the spacer surface is 0.5 μm or less. This result confirms that a higher voltage can be applied to the anode substrate in the panel of the present invention and thus improving the image quality.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An image display device, comprising:
a cathode substrate with a cold cathode electron emitting device formed thereon, an anode substrate with a phosphor formed thereon, and a spacer disposed between and supporting the cathode and anode substrates; wherein:
the spacer is made of a phosphate glass having transition metal oxides as its main components, and the thickness of a higher phosphate concentration layer at the spacer surface is 0.5 μm or less.

2. An image display device according to claim 1, wherein:
a transition metal oxide contained in the phosphate glass is at least one selected from a group consisting of vanadium oxides, tungsten oxides and molybdenum oxides.

3. An image display device according to claim 1, wherein:
the phosphate glass includes one of: a W—V—P—Ba—O glass which contains tungsten oxides and vanadium oxides, and further contains phosphorus oxides and barium oxide as a vitrification component; and a W-V-Mo-P-Ba-O glass which further contains molybdenum oxides in addition to the W—V—P—Ba—O glass.

4. An image display device according to claim 3, wherein:
the phosphate glass contains substantially no alkali metal.

5. An image display device according to claim 3, wherein:
the amount of alkali metal in the phosphate glass is suppressed to 0.5 mass % or less in terms of oxide.

6. An image display device according to claim 1, wherein:
a specific resistance of the spacer is an order of 10⁷ to 10¹⁰ Ωcm.

7. An image display device according to claim 1, wherein:
an anode voltage applied to the anode substrate is within a range of 10 to 15 kV.

8. An image display device, comprising:
a cathode substrate with a cold cathode electron emitting device formed thereon, an anode substrate with a phosphor formed thereon, and a spacer disposed between and supporting the cathode and anode substrates; wherein:
the spacer is made of a phosphate glass having transition metal oxides as its main components;
the thickness of a higher phosphate concentration layer at the spacer surface being 0.5 μm or less; and
the spacer has on its surface a conductive passivation layer containing highly polar elements.

9. An image display device according to claim 8, wherein:
the conductive passivation layer includes one of tin-based and zinc-based oxides.

10. A spacer for use in an image display device which has the spacer between a cathode substrate with a cold cathode electron emitting device formed thereon and an anode substrate with a phosphor formed thereon, comprising:
a phosphate glass having transition metal oxides as its main components, and a higher phosphate concentration layer at its surface, wherein:
a thickness of the higher phosphate concentration layer is 0.5 μm or less.

11. A spacer according to claim 10, wherein:
a specific resistance of the spacer is an order of 10⁷ to 10¹⁰ Ωcm.

12. A spacer according to claim 10, wherein:
the phosphate glass includes one of: a W—V—P—Ba—O glass which contains tungsten oxides and vanadium oxides, and further contains phosphorus oxides and barium oxide as a vitrification component; and a W-V-Mo-P-Ba-O glass which further contains molybdenum oxides in addition to the W—V—P—Ba—O glass.

13. A spacer according to claim 10, wherein:
the phosphate glass contains substantially no alkali metal.

14. A spacer according to claim 10, wherein:
the phosphate glass includes on its surface a conductive passivation layer containing highly polar elements.

15. A spacer according to claim 14, wherein:
the conductive passivation layer includes one of tin-based and zinc-based oxides.
